(19) United States
(12) Patent Application Publication
(10) Pub. No.: US 2005/0187790 A1
(43) Pub. Date: Aug. 25, 2005

(54) Reusable discount card and prescription drug compliance system

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 10/865,491

(22) Filed: Jun. 10, 2004

Related U.S. Application Data
(63) Continuation-in-part of application No. 10/785,930, filed on Feb. 24, 2004.

(51) Int. Cl. G06F 17/60

(52) U.S. Cl. 705/2

(57) ABSTRACT

A prescription drug compliance and reusable discount system having enhanced patient privacy that provides reminders and offers incentives to patients to continue the taking of prescription medications.

### CROSS-REFERENCE TO RELATED APPLICATIONS

This application is a continuation-in-part of co-pending application Ser. No. 10/785,930 filed Feb. 24, 2004, and the entire disclosure of all applications are incorporated herein in their entirety.

### DESCRIPTION

### BACKGROUND AND SUMMARY OF THE INVENTION

While prescription drugs are modern miracles in preserving and extending a person's life, not taking prescriptions as required (non-compliance) has become a major health problem. Additionally, people who may be only partially insured (such as the elderly), or wholly uninsured (such as lower income populations), or those who are too busy or forgetful in their daily lives to procure medications, are prone to discontinue or not to fill prescriptions as directed.

Non-compliance in prescription drug taking is putting an enormous strain on the health care system today. Estimates of cost to the United States economy range from 50 to as high as 100 billion dollars per year. It is estimated that 17 percent of all Emergency room visits are the direct result of a prescription drug misdirection (non-compliance). Other results of non-compliance include hospital and nursing home admissions, as well as lost wages and lower productivity. Moreover, the most pressing aspect of non-compliance is reflected in the fact that compliance drops off dramatically when it comes time to refill a prescription. It is known by insurance estimates that for ongoing prescriptions, after one year from beginning a prescription regimen, approximately 60% of patients no longer continue taking or refilling the required medication. This represents an unhealthy dynamic that costs both employers, insurance companies, and society at large greatly over time.

As the population ages, non-compliance becomes a source for even more concern. Population experts say in the year 2003, 83 million Americans were over the age of 50, and by the year 2010, that figure will be over 100 million. In addition, as prescription drugs become more expensive, and as government and employer funded coverage for such drug plans becomes less comprehensive, compliance becomes even more so of a concern for doctors who are concerned about their patients following through with treatments, as well as for insurance companies who wish to reduce the resulting costs of non-compliance, and also for patients who yearn for a less expensive form of compliance.

Currently no system exists to assure long-term compliance in the taking of prescription drugs. Known compliance systems have provided for various methods of notification to ensure compliance. Various methods of such notification include pager systems cable set top boxes for use in homes and adult care centers may enable the broadcasting of reminders but are aimed at providing “strong arm” tactics, such as annoying messages on pagers, set top boxes and the like. Prior art systems do not address the root of the problem in non-compliance, which is motivation, something which is often compromised by ongoing financial concerns associated with prescription fulfillment. While these systems may attempt to provide some form of compliance, none actually encourage or motivate a patient through financial incentives to comply with a drug prescription on a sustainable basis. Particularly, none of these systems provide both a means of notification and an incentive for a given prescription medication to be taken. Moreover, none of these systems are aimed at addressing the difficulty of long term compliance, especially within the strict confines of medical confidentiality, such as that mandated under more recent legislation such as the Health Insurance Portability and Accountability Act (HIPAA).

As such, if a means were developed to motivate, rather than merely remind patients to take a prescribed medication, then compliance especially on a long term basis would be greatly enhanced. Any financial cost involved in such a system would be vastly outweighed by the cost savings for the care of chronically ill patients and the growing aged population.

Accordingly, the present invention relates to the purchasing and taking of prescription drugs through a incentive based compliance system. The system incorporates third party monitoring stemming from an initial participation decision by a patient who has been influenced by the prospect of ongoing (e.g., multiple use) discounts for a given prescription. Pharmacy participation incentives, HIPAA-compliant medical monitoring, and financial incentives for all parties (patient, insurer, etc.) are additional benefits to this invention.

### BRIEF DESCRIPTION OF THE DRAWINGS

FIGS. 1A and 1B are a depiction of an exemplary reusable discount card and solicitation/sign up means contemplated by the inventive system;

FIG. 2 is a rendering of the major connected elements of the inventive reusable discount card and prescription drug compliance system; and

FIG. 3 is a flowchart detailing an exemplary process that might be employed in executing the inventive method and functions of the system.

### DETAILED DESCRIPTION OF THE DRAWINGS AND PREFERRED EMBODIMENTS

In its broadest aspect, the present invention provides for a prescription drug compliance and discount payment system at least one reusable discount means having a confidential identification number, a solicitation means associated with each reusable discount means for soliciting a patient consent and patient information, an activation means for receiving said patient consent and patient information received from the solicitation means and for activating a patient participation record related to the confidential identification number, a processor means for receiving the confidential identification number and for receiving a prescription fulfillment transaction, as well as for awarding incentives based on said receipt of each identification number and prescription fulfillment, to patients and participating businesses associated with each said fulfillment transaction, and a compliance means for ensuring a continuing of a prescription compliance of each said patient participation record.

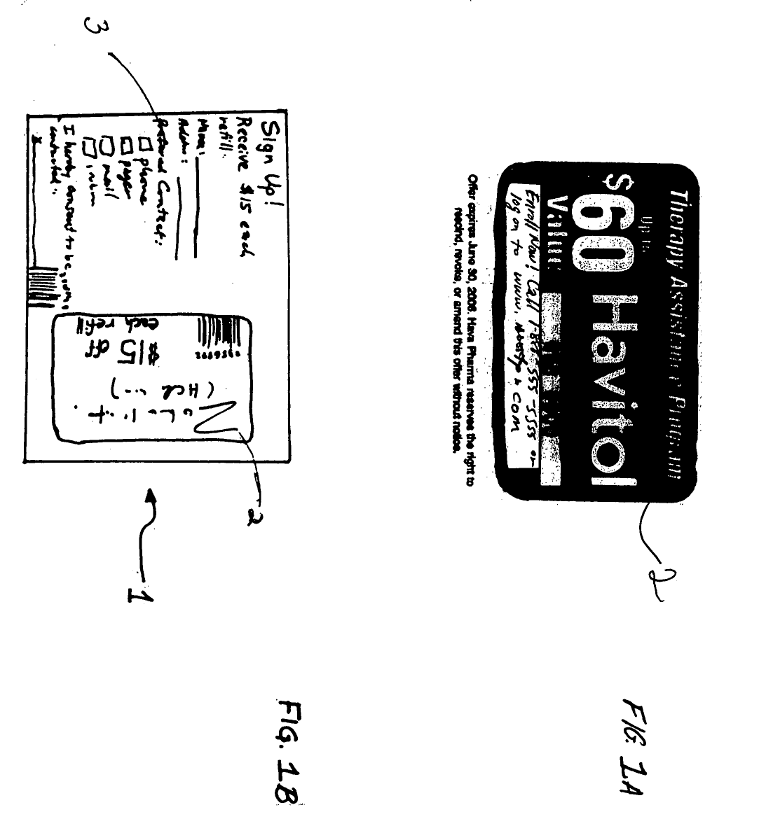

FIGS. 1A and 1B depict a reusable discount means such as reusable discount card 2. In FIG. 1A, there is a solicitation means such as a contact gateway, such as a toll free number or website for signing up (provided for those who might not wish to sign up by mail), while in FIG. 1B is a solicitation/sign up portion 3 (provided for those who might prefer to sign up by mail), together forming one unit on an informational backing 1 of the inventive reusable discount card and prescription drug compliance system. Although many variants of the reusable discount means and solicitation may be envisioned, either approach to signing up may be utilized, whether provided alone or in combination with each other. According to one embodiment, reusable discount card 2 will be a standard plastic (or paper) card, preferably detachably affixed by gum-like glue to an informational backing 1, and will have printed product information, discount information, and a unique identifier and transaction code means (embodied by a bar code, smart chip, and/or magnetic stripe, etc.), but most preferably simply embossed or typed on the card. Such a unique identifier and transaction code means will be one of the preferred ways of activating and tracking the discount card usage. Where the unique identifier and transaction code means is, for example, a bar code, such activation and subsequent card usage may be tracked by the use of a common bar code scanner device well known in the art of retailing and cash register technologies. However, in order to facilitate widespread usage of the inventive system through existing pharmacy networks, the numeric representation may be simply typed or otherwise entered into an existing pharmacy system for entering and processing secondary insurance-type information for prescriptions.

Accordingly, where a patient consents to enrolling in the discount compliance program, his name, address, indication of consent, preferred means of receiving future reminders, and other information can be received through mail, email, or via phone, by an Opt-In Center 9 into a database (not depicted) (either through manual data entry input, or through form-based scanning as known in the art). The solicitation/sign up portion will therefore, typically have a confidential identification number contained within the unique identifier and transaction code means that has been recorded at the time of printing for identifying the type of prescription drug (and refill specifics as needed). In a more particular embodiment, this confidential identification number will be the above-referenced numeric representation, and will be printed or embossed directly on the card. Hence, the inventive system will most preferably have the unique identifier and transaction code means printed at least on the card and on the solicitation/sign up portion 3 so that the confidential identification number contained therein can function as a confidential tracking number so that the two pieces may be separated (e.g., for convenience of carrying, or where the solicitation/sign up portion is sent in to Opt-In Center 9, and the card is retained for use each time at pharmacy 7).

When the card is presented at the pharmacy 7, the system will be providing a way of correlating information from the solicitation/sign up portion and the card usage thereafter. Preferably, in a given usage the confidential identification number will be one from a grouping of codes that have been assigned by the Loyalty Reimbursement Program 12 at the initiation of the card provision process at 4, so that when enrollment cards are supplied to pharmaceutical sales representatives at 5, a specific range of confidential identification numbers will be known to have assigned to a given physician at 6 at the time of card distribution. When provisioned as such, usage by patients 8 thereafter at pharmacy 7, will, as referenced above, provide a way for the Loyalty Reimbursement Program 12 to be able to correlate the entirety of patient information received by Opt-In Center 9 with the confidential identification number received by Pharmacy Benefits Processor 11, when the Pharmacy Benefits Processor 11 receives from pharmacy 7 the confidential identification number that will accompany the transmission of the occurrence of a prescription transaction being fulfilled at pharmacy 7 by patient 8. Storing the information at Opt-In Center 9 at the time of opt-in allows pharmacy 7 to participate in the reimbursement program without transmitting private patient health information that might be prohibited under HIPAA and other privacy regulations. Moreover, the pharmacy need not concern itself with patient consent, as it transmits only the date and time stamped transaction containing the confidential identification number associated with the transaction.

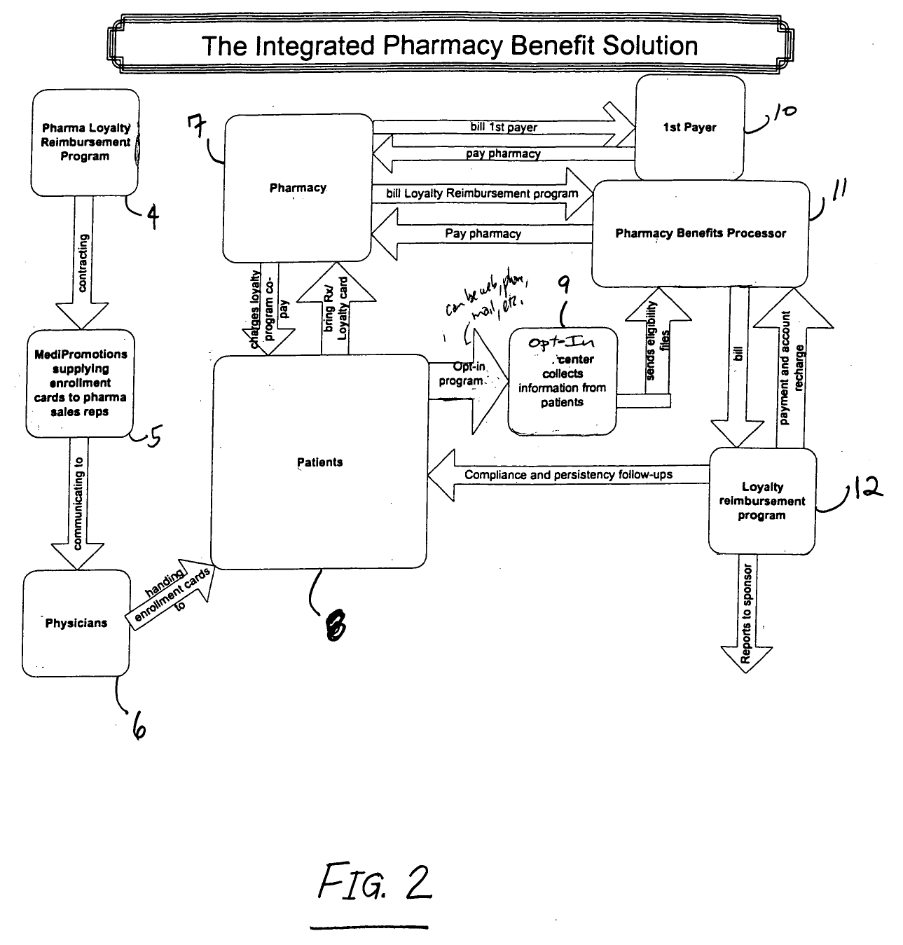

FIG. 2 shows the major elements of the system. Ideally, the pharmacy 7 and Opt-In Center 9 will be connected to each other via some form of network means, such as the internet, where they can communicate in real time as needed, or where they can just send coded transaction data and reimbursement information data to each other as needed through regularized, instant transmission of transaction data. Where the patient has indicated a preference for internet (email) or phone notification, there will be an internet, cable, phone, or other type connection with the patient.

By way of more specific illustration, a preferred process within the inventive system might begin with the patient's doctor writing a prescription, and at that time the doctor would hand him the sign up/consent 3 and the attached reusable discount card 2. The patient's doctor would normally write the prescription containing the following information: patient's name, doctor's name, drug name indicating whether or not generic replacement is acceptable, and prescription length/refill availability. Patient 8, ideally motivated by the idea of incentives (e.g., preferred discounts stated herein), together with his physician's recommendation, will therefore be inclined to participate. The Opt-In Center 9 would receive the completed solicitation sign up card 3 (or at least the raw data therefrom, if done remotely, rather than in-person) for the first filling of a given prescription. The completed solicitation sign up card 3 has a confidential identification number, described above, that is identical to the one on the reusable card 2 and can be used to track filling of prescription and correlate the related patient information for each use of the reusable card 2. The Opt-In Center 9 would have an eligibility and compliance to contain at least the above information for sharing or wholesale transfer to Pharmacy Benefits Processor 11 and/or to Loyalty Reimbursement Program 12, as needed, in order to provide the discounts to patient 8 and reimbursements and participation fees to participants, such as pharmacy 7. The confidential identification number from the reusable discount card 2 can be formed as a time and date-stamped data packet, and can be sent to the Pharmacy Benefits Processor 11 via a network, instantly through an established communication link such as satellite, frame relay, PSTN, LAN or WAN or POTS. In an especially preferred embodiment, a communication link between the Pharmacy Benefits Processor 11 and the pharmacy 7 would be a dedicated T2 type or better, or satellite connection. The Pharmacy Benefits Processor 11 could then download the confidential identification number in real time. The following data might then be received at the Opt-In Center 9: prescription number; dosage amount; drug type; and date billed. From the confidential identification number received in each transaction, the Loyalty Reimbursement Program 12, via the Pharmacy Benefits Processor 11, could correlate the date and time of the prescription being filled with the confidential identification number. The confidential identification number would enable the correlation by enabling a retrieval of the primary care giver name, address and phone number; patient name; preferred notification methodology (internet; cellular or land line phone number; pager serial number); and proof of consent that already resides in the database at Opt-In Center 9 and/or Benefits Processor 11.

In a most preferred embodiment, however, Opt-In Center 9 would be the central location of all patient, doctor, prescription, and/or insurance, bar code or magnetic strip data. This would allow the Pharmacy Benefits Processor 11, and the Loyalty Reimbursement Provider 12 to more effectively coordinate the drug specific discount transactions. Pharmacy Benefits Processor 11 would verify that a given card is only being used for one patient's medication, and furthermore, has not expired or exceeded the maximum allowable multiple discounts provided (typically two years maximum, although this limit will ultimately be dependent on the specific business model needed for the specific drug(s) that the card has been issued.)

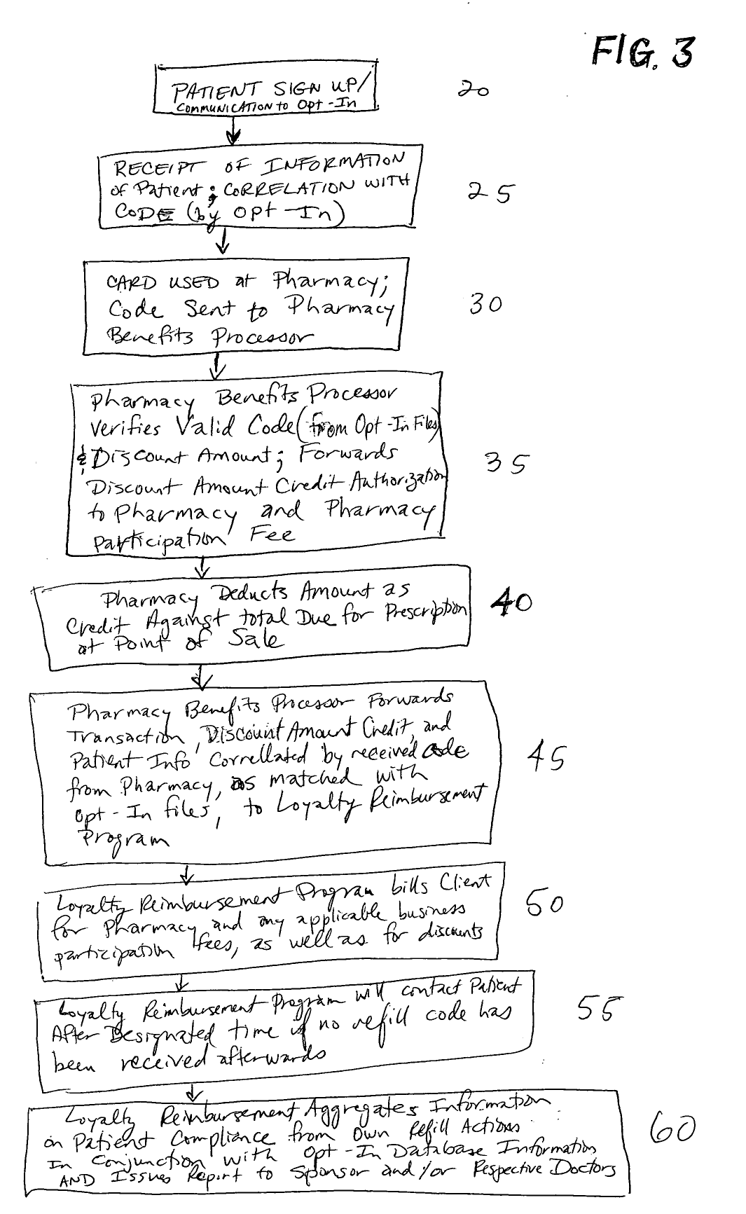

Turning to FIG. 3, with ongoing cross-reference to FIG. 2, is an illustration, in flow diagram form, of the theory of operation of the inventive system. Beginning with patient sign-up at 20, the prompting of receipt of information occurs at 25, which then leads to card activation at 30, all of which may be logistically accomplished as described above. As also detailed above, once a patient has filled an initial prescription, the patient will have already signed up and the reusable discount card 2 will have been initialized through the mail, or by having called Opt-In Center 9 directly. In one embodiment, any pharmacy 7 will be able to communicate with the Pharmacy Benefits Processor 11 through phone, or in one embodiment through a network/internet connection, as described above, where simple software, as known in the art for retailing, has been installed at a pharmacy 7. In a preferred embodiment, however, pharmacy 7 would not need to install such software, as the confidential identification code may simply be transmitted to Pharmacy Benefits Processor 11 by manual entry of the numerical representation or confidential identification code into currently existing pharmacy based systems for fulfilling prescriptions with secondary insurer benefits. Such simplicity of implementation and operation, in addition to the monetary benefits described hereafter for a pharmacy 7 would help solicit participation of a given pharmacy 7 within the inventive system.

It can then be determined utilizing the previously received prescription refill information detailed above by automated processing (similar to well known automated billing programs that can ascertain as to whether a payment has been sent in response to a bill) at pharmacy benefits processor 11, whether a refill has been processed at 35 by the networked pharmacy 7 within the designated refill timeline.

However, in a most preferred embodiment, when a patient comes to refill a prescription at the networked pharmacy 7, then the pharmacy 7 will be able to input the confidential identification number by swiping the reusable discount card 2 at a swipe terminal (not depicted) much like swipe technology that is currently well known in the art of credit card processing. As detailed above, a magnetic strip is preferably provided on reusable discount card 2 so that it can be read by the swipe terminal, such that the refill transaction can be immediately transmitted to the automated processing at Pharmacy Benefits Processor 11. Thereafter, the predetermined discount stated on the given card (the amount and duration of which is necessarily different for each type of medication, depending on manufacturer terms) is ideally encoded within the magnetic strip on the back of the card so that it can be immediately applied, step 40, as needed, to the payment that may be required at that particular time from the patient or first payer 10. Except in cases of Medicare patients, or where otherwise prohibited by law, Pharmacy Benefits Processor 11 will apply the discount immediately at time of payment at 45 through an electronic credit authorized to the pharmacy 7. The Pharmacy Benefits Processor 11 will then pay pharmacy 7 a reimbursement for the point of sale discount, plus an agreed upon participation fee at 50. The participation fee will ultimately be born by the pharmaceutical client of the Loyalty Reimbursement Program 12, who will utilize the Pharmacy Benefits Processor 11 for regulating the actual execution of payments and reimbursements with patient 8 and pharmacy 7.

In one alternative embodiment, instead of in-person presentation at a pharmacy, the present invention provides for the card to be used over the phone or through the mail as is currently popular when filling prescriptions. In such cases, rather than utilizing a scan, the confidential identification number, or other number such as the a bar code number or other serial number that represents the confidential identification number, may be written down on a refill form for mailing to Opt-In Center 9, input on a web page form on the internet for transmission to Opt-In Center 9, or may be communicated over the phone to a live representative or to a voice activated automated system at Opt-In Center 9. The amount of discount could be accounted for by the automated system of the customer service center when payment is required during the transaction.

However, if the refill has not been processed according to a set of terms associated with a patient's particular prescription need, (e.g., within the refill time period), then an automated reminder 40 can be sent from the Loyalty Reimbursement Processor 12 to patient 8 via the means designated by the patient originally on the solicitation/sign up portion 3. The automated reminder, as suggested earlier, could be conveyed at 55 in any one (or several) types of means preferred by the patient. If the user does not refill the prescription after two (2) reminder attempts by the Loyalty Reimbursement Program 12, the primary caregiver may be notified, if required by the insurer. Although the primary motivation is based on the discounts applied, this action would additionally motivate the user to be in compliance. Dates of non-compliance, as well as caregiver notification might, in certain embodiments, all be recorded in a database at Loyalty Reimbursement Program 12. Thereafter, information regarding patient compliance may be aggregated to form broad pictures of compliance by groupings of patients. Such compliance might then be given to physician 6 as doctor-specific feedback or other type of an informational representation of doctor's patient base compliance. Provision of such information in this manner would not only be HIPAA-compliant, but would also be useful to physicians 6 in improving or understanding their own practice and/or patient base, as well as for insurance and/or pharmaceutical business purposes.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure. Modification of this method and apparatus can become clear to a person having ordinary skill in this particular art; all such modifications are clearly covered by this disclosure.

1. A prescription drug compliance and discount payment system comprising:
(a) at least one reusable discount means having a confidential identification number;
(b) a solicitation means, associated with each said reusable discount means, for soliciting a patient consent and patient information;
(c) an activation means for receiving said patient consent and patient information received from said solicitation means and for activating a patient participation record related to said confidential identification number;
(d) a processor means for receiving said confidential identification number, and for receiving a prescription fulfillment transaction, and for awarding incentives based on said receipt of each said identification number and said prescription fulfillment to patients and participating businesses associated with each said fulfillment transaction; and
(e) a compliance means for ensuring a continuing of a prescription compliance of each said patient participation record.

2. The system of claim 1, wherein said confidential identification number allows collection of information representing said prescription compliance of at least one patient participation record for medical purposes.

3. The system of claim 2, wherein said medical purposes includes a doctor-specific feedback on patients.

4. The system of claim 3, wherein said incentive further includes a monetary payment to a pharmacy in response to said receipt of said prescription fulfillment by said processor means.

5. A method of ensuring prescription drug compliance by offering incentives, said method comprising:
(a) assigning a confidential identification number to a reusable discount means;
(b) recording said confidential identification number associated with a respective reusable discount means;
(c) issuing said reusable discount means to a patient having a prescription need;
(d) obtaining a patient consent and patient information assorted with said prescription need by offering of said incentives to said patient;
(e) activating a patient compliance record associated with said patient consent and patient information for a determined time period;
(f) ensuring compliance with a set of terms associated said prescription need by issuance of an incentive to said patient through a pharmacy and through ongoing reminders issued through a preferred means of communication; and
(g) soliciting participation of said pharmacy by offering a monetary benefit to said pharmacy for filling a prescription need.

6. The method of claim 5, wherein said incentives are monetary discounts on a price assigned to a given prescription need, and wherein said monetary discounts are immediately available to said patient at time of prescription fulfillment.

7. The method of claim 6, further comprising the step of collecting a set of patient data based upon said patient compliance record and said patient information for medical purposes.

8. The method of claim 7, wherein said step of collecting said set of patient data for medical purposes comprises further includes the step of aggregating said patient data for delivery to a doctor associated with the patient data.
